(19) United States
(12) Patent Application Publication
(10) Pub. No.: US 2011/0162732 A1
(43) Pub. Date: Jul. 7, 2011

(54) ANTI-SIPHON CHECK VALVE

(76) Inventor: Vincent P. Biel, Belleview, FL (US)

(21) Appl. No.: 12/779,594

(22) Filed: May 13, 2010

Related U.S. Application Data
(63) Continuation-in-part of application No. 12/683,496, filed on Jan. 7, 2010.

(51) Int. Cl. F16K 15/18; B21D 53/10

(52) U.S. Cl. 137/538; 29/890.121

(57) ABSTRACT

An anti-siphon check valve assembly 20 has an upper portion 4 body housing with a shut off seat 9 or seal 6 and a lower portion 3 body housing for attachment to the upper portion 4 body housing. Inside the body housing is an internal float 5 and a compression coil spring 8. The internal float 5 has a shut off seal 6 for engaging a shut off seat 9. The compression coil spring 8 for biasing the internal float 5 to a shut off position wherein the seal 6 engages the shut off seat 9. The check valve opening force is less than 1 psi, preferably less than 0.5 psi, more preferably 0.25 psi or less. The anti-siphon check valve assembly 20 also has an “O” ring seal 7 to seal the upper portion 4 of the body housing to the lower portion 3 of the body housing. The shut off seal 6 can be made as a washer gasket. The upper portion 4 of the body housing can have a compression fitting male threaded end 42 for use in a compression fitting connection of a water supply line or a shark bite connection assembly 30 for connection to a water supply line 112 or a male pipe fitting end 52 or a female pipe fitting end 62 for connection to a water supply line 112. The valve 20 can be made by modifying an air venting vacuum relief valve 1.

### RELATED APPLICATIONS

This application is a continuation in part application and claims priority to U.S. patent application Ser. No. 12/683,496 entitled “Improved Solar Hot Water Storage System and Dual Passageway Fitting Assembly” filed on Jan. 7, 2010.

### TECHNICAL FIELD

This invention relates to a check valve for water systems employing electric pump motors generally, more specifically to solar heated hot water systems using small dc (direct current) electric pumps to circulate the water from a storage tank to the solar panel and back in the process of heating water.

### BACKGROUND OF THE INVENTION

Heating water for use in bathing, washing clothes, cleaning dishes or operating a dish washer requires a separate heating unit to be used in the plumbing system of a residential house or commercial building.

Traditional water heating systems have used large holding tanks to heat and store the water. These large holding tanks heated the water with either natural gas heaters or electric heating elements. The most common water tanks employ two electric heating elements that are mounted through the side of the tank with a threaded end and connected to a electric power panel on the side of the tank wired to an electric power source. The outside of this standard hot water tank is covered with insulation and an outer shell holds the assembly together. On the top of the tank water lines are connected to an inlet fitting and a supply fitting. The hot water line is connected to plumbing to distribute hot water throughout the building. The tanks are further fitted with a pressure relief valve on the top and a water discharge port near the bottom for periodically flushing sediment build up within the tank.

These electric hot water systems hold and heat typically between 40 and 80 gallons of water and maintain the heated water at temperatures around 120 degrees F. or more. The electric power consumed can be a considerable expense, second only to air conditioning and whole house heating. To reduce these costs several more efficient systems of heating water have been attempted. One such system is solar hot water systems.

Solar hot water systems employ a solar collector mounted in a location where sunlight can heat water as it passes through one or more solar collectors. Typically the solar collectors are mounted on the roof of a building. The water is pumped through the system using a small, generally low flow pump that insures the water can be adequately heated in the solar collectors before it is sent to a solar hot water tank. These solar hot water tanks work in much the same way as a conventional or standard hot water tank, but it has two additional fittings on the top of the solar tank connected to lines for taking water from the tank to be heated by the solar collectors and returning hot water back to the solar tank.

The pumping system is controlled by temperature sensors that monitor the water temperature in the solar tank and shut off or restrict the flow to keep the water temperature in the desired range. At night or dusk the solar system pump is shut off to avoid cooling the water when no solar heat is available. The solar tanks often include auxiliary heating for maintaining the temperature of the water at night if needed.

Solar heated water holding tanks preferably store water heated up to 180 degrees F. A mixing valve is added to the hot water line which enables cold water to mix with the 180 degree F. water cooling it to about 120 degrees F. Thermostatic temperature controls on the mixing valve insure the right amount of cold water is mixed to control the temperature coming out of the faucet at 120 degrees F. This enables the solar heated tanks to hold water at higher temperatures than a standard electric hot water system without a mixing valve. The main difference is the hotter water comes at no added cost due to solar heating.

As can easily be appreciated the use of solar heated water eliminates the use of and demand for electricity in daylight hours meaning no electricity is used to heat water during peak demand times. This reduces energy consumption and helps reduce the cost of electricity. One major problem is the electricity savings are offset by rather expensive equipment costs. The additional cost of plumbing, solar collectors, pumps, controls and a solar tank means most users of hot water will not spend the money to install such a system.

The solar systems can cost $2,500 to well over $5,000 or more. One large cost is replacing or adding to the existing standard hot water tank. A solar tank costs $800 to $1,200. This expense when combined with the additional components required makes the initial expenditure so high that the pay back in cost savings takes many years.

In a related invention a unique way to virtually eliminate the cost of a new water holding tank and enables a pre existing standard electric hot water tank to be adapted for use in combination with a solar collector system enabling solar heated water to be used with almost any conventional hot water storage system that uses electric heating elements. This invention entitled “Improved Solar Hot Water Storage System and Dual Passageway Fitting Assembly” was filed as U.S. patent application Ser. No. 12/683,496 on Jan. 7, 2010 and the subject matter of that invention is as illustrated in FIG. 9 and is incorporated by reference herein in its entirety.

Regardless of the type of solar hot water tank or system used, a small low volume pump motor is placed in the lines to deliver water from a storage tank to the solar collector when it is heated and returned back to the tank. These pumps are typically very compact with relatively small direct current (dc) motors and they are relatively susceptible to damage if exposed to large flow resistance. One source of flow resistance is the use of anti-siphoning check valves. Typically, one anti-siphoning check valve is employed in each solar system on the line feeding the solar heated water to the storage tank. This check valve stops hot water from back flowing up the line when the solar pumps are turned off such as occurs at night. The back flow is called siphoning, and due to the thermal or temperature difference, the entire solar system would reverse flow if left unchecked, effectively cooling the previously heated water.

To prevent this siphoning from occurring, anti-siphon water check valves are often used. These check valves are normally in the closed or shut position unless the pump is running. When the pump runs, a pressure builds up overcoming the check valve causing it to open. A typical check valve uses a strong spring force to keep the valve closed; the pump must constantly overcome the spring force to deliver or move water in the lines. This creates a flow resistance which makes the pump work harder than otherwise required. This added load on the pump motor, particularly low flow dc pump motors, causes damage and premature motor failures.

The present invention has found a low cost alternative check valve concept that reliably prevents siphoning without creating a noticeable load on the pump motor. The present invention provides a check valve substantially lower in cost, but with a very low opening spring force which greatly reduces the load on the pump motor.

### SUMMARY OF THE INVENTION

An anti-siphon check valve assembly has an upper portion of the body housing with a shut off seat and a lower portion of the body housing for attachment to the upper portion body housing. Inside the body housing is an internal float and a compression coil spring. The internal float has a shut off seal for engaging a shut off seat. The compression coil spring for biasing the internal float to a shut off position wherein the seal engages the shut off seat. The check valve opening force is less than 1 psi, preferably less than 0.5 psi, more preferably 0.25 psi or less. The anti-siphon check valve assembly also has an “O” ring seal to seal the upper portion of the body housing to the lower portion of the body housing. The shut off seal can be made as a washer gasket. The upper portion body housing can have a compression fitting male threaded end for use in a compression fitting connection of a water supply line or a shark bite connection assembly for connection to a water supply line or a male pipe fitting end or a female pipe fitting end for connection to a water supply line. The valve can be made by modifying an air venting vacuum relief valve.

A method of making an anti-siphon valve has the steps of disassembling a vacuum relief valve having an upper portion body housing, threaded into a lower portion body housing, an O ring, a float with a seal, a compression spring and a vacuum vent end cover; discarding the vacuum vent end cover; brazing, welding or otherwise affixing a threaded end fitting onto the upper portion body housing forming a modified upper portion body housing; and reassembling the float with seal and spring into the modified upper portion body housing and attaching the O ring to the upper portion body housing and reattaching to the lower portion body housing for form the anti-siphon valve.

### BRIEF DESCRIPTION OF THE DRAWINGS

The invention will be described by way of example and with reference to the accompanying drawings in which:

FIG. 1 is a cross sectional view of a prior art air venting vacuum relief valve.

FIG. 2 is an exploded view of the prior vacuum relief valve shown in FIG. 1.

FIG. 3 is cross sectional view of a modified check valve made according to the present invention wherein the vacuum relief valve of FIGS. 1 and 2 has been modified to work as an anti-siphon check valve.

FIG. 4 is an exploded view of a modified check valve of FIG. 3 made according to the present invention.

FIG. 5 is a cross sectional view of the check valve made according to the present invention using a compression fitting.

FIG. 6 is a cross sectional view of the check valve made according to the present invention using a shark fitting.

FIG. 7 is a cross sectional view of the check valve made according to the present invention having a male pipe fitting end.

FIG. 8 is a cross sectional view of the present invention employing a female pipe fitting end.

FIG. 9 is a schematic view of the present invention check valve employed in a solar hot water heating system.

### DETAILED DESCRIPTION OF THE INVENTION

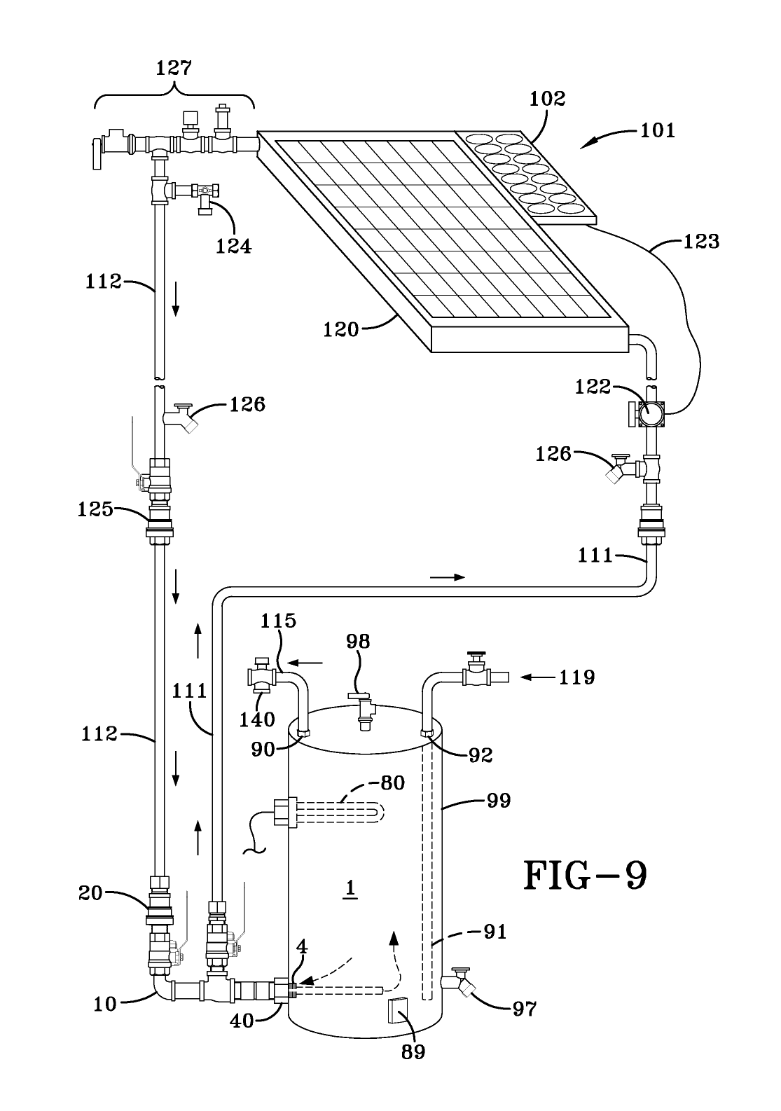

As shown in FIG. 9, an anti-siphon check valve 20 is attached to the dual passageway valve 10, the hot water side connected to line 112 of the solar system 101. This anti-siphon check valve 20, as illustrated, prevents hot water from flowing from the tank 99 back up through the line 112 when the pump 122 is shut off. Normally shut off of the pump occurs at night when the temperature is cooler. At night, water in the solar panel is cooled rapidly creating a thermal temperature differential wherein the hot water in the tank, in the absence of the check valve, will flow back up the line 112 into the solar panel and back through line 111 into the tank 99 creating a siphoning effect that would continuously drain the tank 99 of its hot water due to the thermal gradient until a temperature equilibrium is achieved. When this occurs, all the water in the tank 99 will achieve an ambient temperature equivalent to the outside air temperature. Naturally, this is counter productive to the use of solar hot water heating systems and accordingly a check valve has been required to be employed in these types of systems to prevent the hot water from drawing back up into the hot water supply line to avoid cooling in the tank.

Conventional hot water check valves provide a one way flow valve that enables a pump to overcome an internal shut off seal within a valve that is typically spring loaded. These conventional prior art check valves require a significant amount of force to hold the seal open and enable a continuous flow of water to occur. This force or pressure differential created by the check valve enables the flow of water to occur constantly as long as the pump can deliver a sufficient pressure differential on the check valve seal to create a compression of the spring allowing the check valve seal to open and remain open during the flow of the water. As a result of this overcoming a spring force, the electric motor in the pump is constantly experiencing a load higher than would normally occur just for conventional pumping of the fluid within the system. Unfortunately, this load when placed on small dc motors, has a damaging effect wherein the motor is over worked, over heated and can fail as a result of the use of this type of conventional check valve. To overcome this problem, a new check valve was needed wherein the pump could provide low volume flow without having to overcome a large spring force at the check valve.

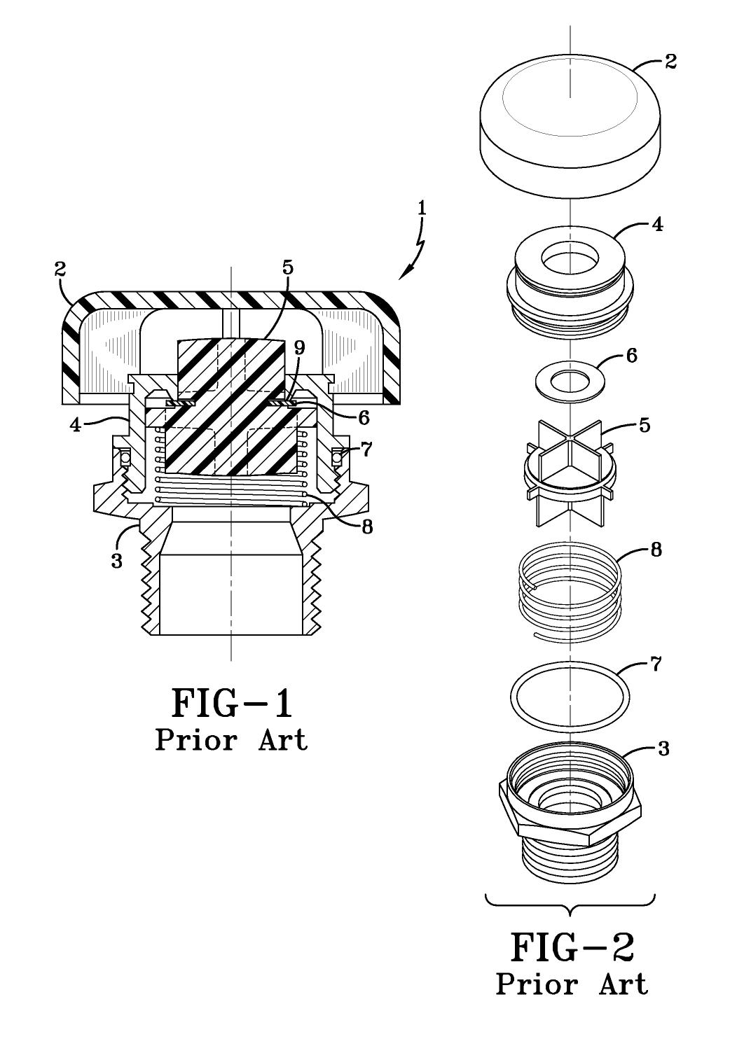

With reference to FIG. 1, a prior art air vent vacuum relief valve 1 is illustrated. The air vent vacuum relief valve 1 provides for automatic venting of a closed system to the atmosphere when a vacuum is created. This prior art vacuum relief valve 1 enables air to enter into a storage tank and prevent vacuum conditions that could siphon the water from the system. If a vacuum condition occurs in a closed tank, the tank could collapse or it could cause the electric heating element to burn out. These automatic air vent vacuum systems are provided in some hot water tanks. What is unique about such vacuum relief valves is that the amount of spring force required to open the valve is dramatically reduced. The amount of vacuum needed to open the seal is less than one quarter of a psi. The prior art device shown in FIGS. 1 and 2 is Model N36-M1, distributed by Watts, Water Safety & Flow Control Products, however any similar low opening force air vent valve may be similarly modified if the basic design is similar.

As illustrated in FIGS. 1 and 2, this prior art vacuum relief valve 1 has a cover 2 typically of polypropylene and shut off disk or seal 6 made typically of silicone. A float 5 which is primarily made of glass filled polysulfone and a spring 8 made of 302 stainless steel is illustrated. The body parts include a threaded fastener lower portion body housing 3 and an upper portion body housing 4, when these two components are assembled, there is an O ring seal 7 between the assembly of body parts 3 and 4 that prevents fluid leakage and provides an air tight seal between the parts. As a vacuum is created, the spring 8 is compressed as the outside pressure is higher than the internal pressure in the tank. In order to prevent any vacuum within the tank, it is important that the valve 1 opens under extremely low vacuum thereby eliminating the risk of any vacuum conditions occurring within the tank where feasible.

These air venting vacuum relieve valves are used on hot water tanks, they are designed to handle temperatures a maximum of 250 degrees F. or 120 degrees C. and have a maximum steam working pressure of 15 psi or 1.03 bars. By using a low compression spring force, the vacuum relief valve 1 can operate and open in pressures at or less than 1 psi typically at 0.25 psi differentials. This unique feature of such a vacuum relief valve 1 means that the seal can be easily opened with virtually little flow resistance.

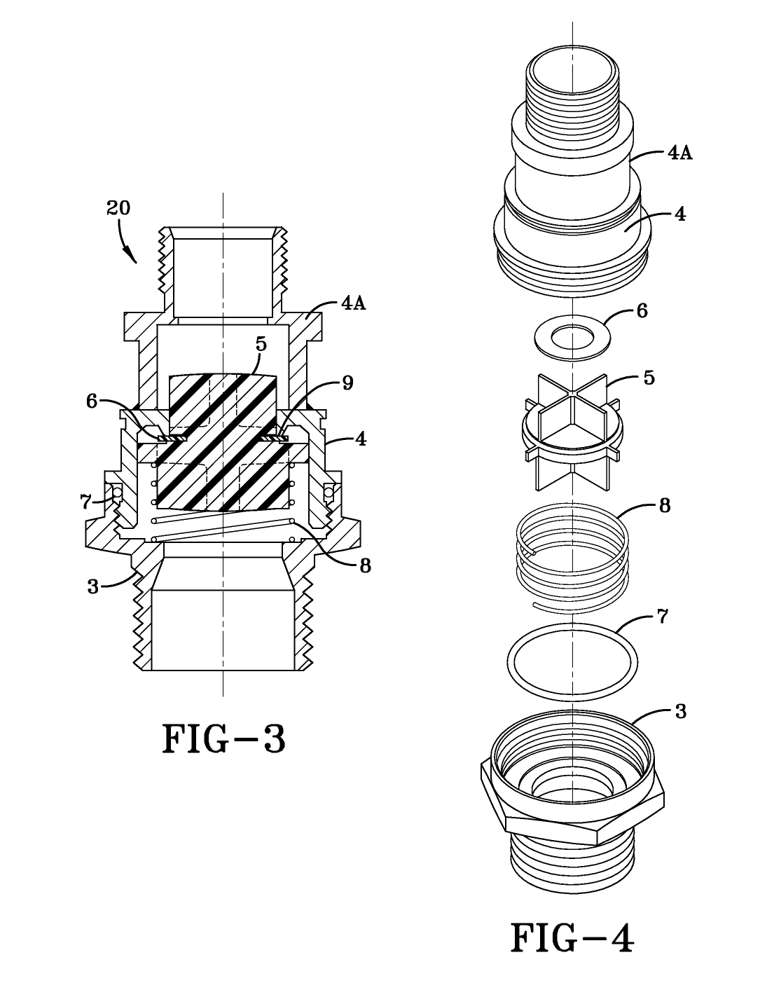

With reference to FIG. 3, there is shown a cross sectional view of an anti-siphon pressure relief valve 20 made according to the present invention. As shown, this pressure relief valve 20 has taken the components of the conventional vacuum relief valve 1 and modified them in such a fashion that they will work in line in a water system. In order to achieve this result, the vacuum relief valve 1 as illustrated in FIGS. 1 and 2 had to be disassembled in such a fashion that the neoprene O ring 7, the float 5 and the stop disk or seal 6 were removed as well as the spring 8 and upon disassembly, the upper portion 4 of the body housing had an additional upper adapter fitting 4A welded or otherwise brazed flat top surface of the upper portion 4 of the body housing. This created a structure that when reassembled, enabled the upper portion 4 to be attached directly to the line 112 of the hot water side of the system 101. With the valve 20 connected inline, the lower portion 3 of the body housing of the valve assembly 20 could be connected either into the dual passageway valve 10 as illustrated or anywhere inline where a threaded connection could be made. It is important to understand that these low pressure differential actuating check valves can be inserted anywhere into a fluid line, in order to achieve a very low opening resistance to minimize the load put on a pump motor. As shown, once the upper adapter fitting 4A has been brazed onto the upper portion 4, the other components can then be reassembled as illustrated in FIG. 3. Once reassembled, the valve assembly 20 is ready to be inserted inline to act as an anti-siphon valve for solar heated water systems or any other water system needing a low operating force check valve.

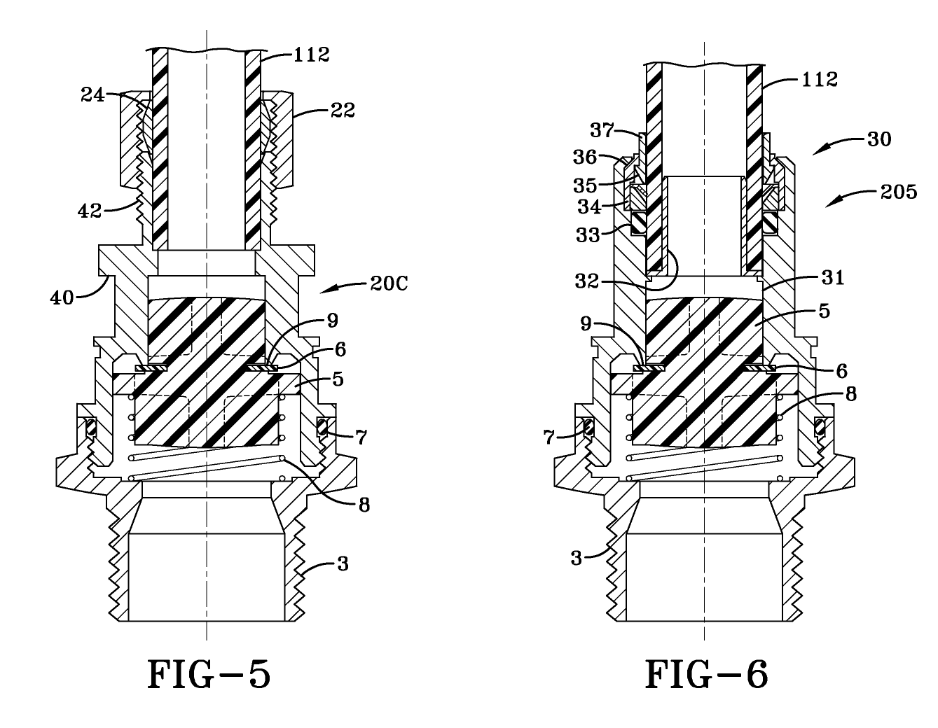

With reference to FIGS. 5, 6, 7 and 8; the anti-siphon check valve 20 of FIG. 3 which was designed from a modified vacuum relief valve 1, can be made in a variety of production alternative versions. As shown in FIG. 5, the valve 20C has a compression fitting using a nut 23 and compression sleeve 24 wrapped around the tubing 112, which can be inserted and can be attached to a threaded end 42 of the upper portion 40. The upper portion 40 of the body housing can be made as an integral one piece machined brass part, if so desired. Alternatively, as shown in FIG. 6, the anti-siphon check valve 20S of the present invention could be made with a shark fitting end at the upper portion 30. A shark fitting end has a tube liner 31 that fits inside the tube 112 and rests on a stop 31. The fitting has a gasket O ring 33 that wraps around the tube 112, a protection ring 34 in the shape of a wedge, a grab ring 35 that is mounted internal of the housing wherein the grab ring 35 bites into the tubing 112 and above the grab ring 35 is a cartridge ring 36 which pushes against the wedge 34 driving the grab ring 35 into engagement. In order to remove the tubing, a dismount ring 37 is provided which is adjacent to the tubing and it has a wedge like surface that when pushed inwardly, forces the grab ring 35 to move outwardly as well as the wedge 34, enabling the tube 112 to release from inside the upper portion 30 of the body housing of the valve 20S. Shark bite connection systems are commercially desirable and easy to use and they make a good alternative embodiment to the present invention valve 20S when compared to the more conventional compression fitting 20C, as illustrated in FIG. 5.

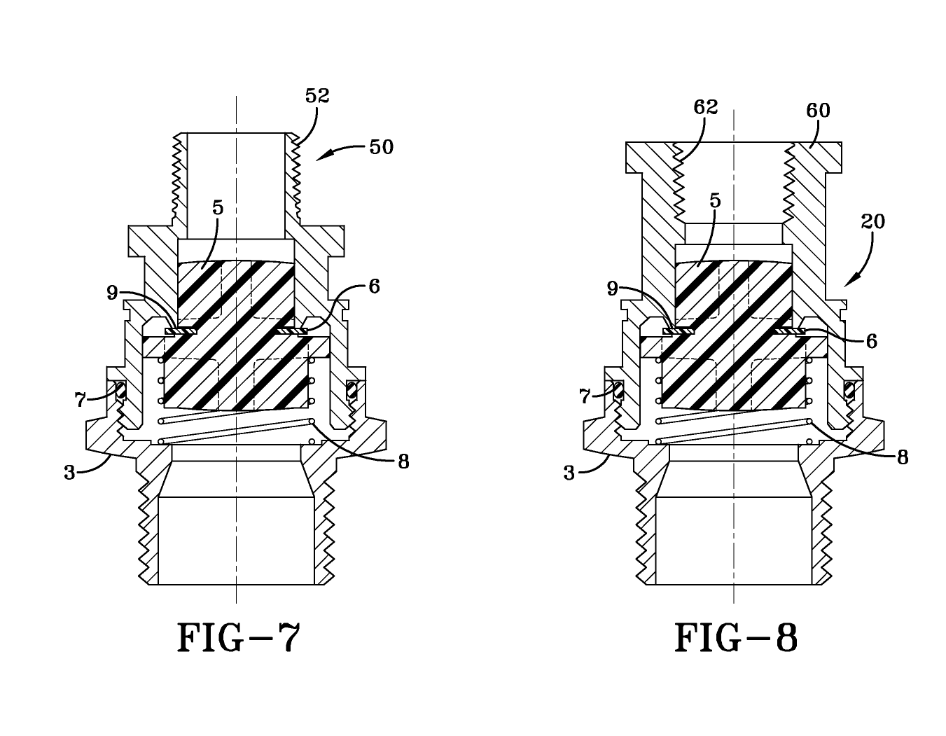

With reference to FIGS. 7 and 8, the check valves 20MP and 20FP according to the present invention can also be made wherein the upper portion 50 of the body housing has an integral male pipe fitting end 52 such that a female pipe end can be threaded onto the check valve 20 MP and it can be inserted inline of a water system. Alternatively, as shown in FIG. 8, this upper portion 60 of the body housing can have a female pipe fitting end 62, as illustrated wherein a male pipe end 52 can be inserted into the female end 62 to make the assembly. As illustrated, in any of the embodiments from FIGS. 3-8, the primary objective is to provide a check valve 20 wherein the stop seal 6 can be engaged to prevent siphoning of hot water back up the pipe or line 112. The important aspect of this check valve 20 is that the spring force employed from the spring 8 is substantially lower than that of conventional check valves. In fact, the spring valve opening flow force is such that the applied force required to overcome shut off is approximately one quarter psi. While this is a very low pressure holding the seal in the shut position, fluid trying to flow or siphon in a reverse direction in the pipe 112 is stopped. This anti-siphon valve operates at such a low open flow pressure that when the pumps are running, the spring 8 only needs to be compressed with a pressure differential of about 0.25 psi to keep the valve open. This 0.25 psi is virtually unnoticeable in the overall system and creates a very low load on the pump motor. By providing this type of check valve 20 in solar hot water systems, very small low volume dc pump motors can be used without the risk of creating excessive loads on the pump motor.

To achieve such a low opening force on the check valve, the spring 8 has a very low spring rate, preferably 2.0 lb/inch deflection or less, ideally 1.0 lb/inch. As shown, the spring 8 has an undeflected height of 0.75 inches, when fully deflected the compressed height is 0.468 inches. The overall diameter of the coil is 0.875 inches and the wire diameter is 0.20 inches. When the spring 8 is assembled it compresses slightly preloading the float 5 and seal 6 against seat 9 stopping any back flow. A small further compression of the spring 8 opens the valve allowing fluid flow. A movement of less than 0.10 inches requires a force of only about 0.1 Lb or less and makes the valve almost unnoticeable to the pump at the low flow rates of 6 gpm typically used in solar water heating systems.

While the present invention has been shown as a modified vacuum relief valve, it is understood that this technology when incorporated into a water check valve system for anti-siphoning, can be employed using numerous fittings and configurations as alternatives, however, the primary principle is that the valve 20 operates at extremely low pressure differentials such that a shut off or back flow can be stopped with an extremely low force yet this low force can be easily overcome by a forward flow of fluid by any pump attached to the system such that the valve seal will open with relative ease.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

1. An anti-siphon check valve assembly comprises:
an upper portion body housing with a shut off seat;
a lower portion body housing for attachment to the upper portion body housing;
an internal float, the internal float having a shut off seal for engaging a shut off seat;
a compression coil spring for biasing the internal float to a shut off position wherein the seal engages the shut off seat; and
wherein the check valve opening force is less than 1 psi.

2. The anti-siphon check valve assembly of claim 1 further comprises:
an O ring seal to seal the upper housing to the lower portion body housing.

3. The anti-siphon check valve assembly of claim 1 wherein the seal is a washer gasket.

4. The anti-siphon check valve assembly of claim 1 wherein the upper portion body housing has a compressing fitting male threaded end for use in a compression fitting connection of a water supply line.

5. The anti-siphon check valve assembly of claim 1 wherein the upper portion body housing has a shark bite connection assembly for connection of a water supply end.

6. The anti-siphon check valve assembly of claim 1 wherein the upper portion body housing has a male pipe fitting end for connection of a water supply end.

7. The anti-siphon check valve assembly of claim 1 wherein the upper portion body housing has a female pipe fitting end for connection of a water supply end.

8. The anti-siphon check valve assembly of claim 1 wherein the check valve opening force is less than 0.5 psi.

9. The anti-siphon check valve assembly of claim 1 wherein the check valve opening force is 0.25 psi or less.

10. A method of making an anti-siphon valve comprises the steps of:
disassembling a vacuum relief valve having an upper portion body housing, threaded into a lower portion body housing, an O ring, a float with a seal, a compression spring and a vacuum vent end cover;
discarding the vacuum vent end cover;
brazing, welding or otherwise affixing a threaded end fitting onto the upper portion body housing forming a modified upper portion body housing; and
reassembling the float with seal and spring into the modified upper portion body housing and attaching the O ring to the upper portion body housing and reattaching to the lower portion body housing for form the anti-siphon valve.
